(19) United States
(12) Patent Application Publication
(10) Pub. No.: US 2014/0299004 A1
(43) Pub. Date: Oct. 9, 2014

(54) CONTAINER COVER DEVICE

(71) Applicants: Anming FU, Dongguan City (CN); Yung Ming SUN, Dongguan City (CN)

(72) Inventors: Anming FU, Dongguan City (CN); Yung Ming SUN, Dongguan City (CN)

(21) Appl. No.: 13/856,827

(22) Filed: Apr. 4, 2013

(51) Int. Cl. B65D 81/20; A47J 47/10

(52) U.S. Cl. CPC B65D 81/2038; A47J 47/10
USPC 99/472; 206/524.8

(57) ABSTRACT

A container cover device having an automatic vacuum function includes a container cover. The container cover is provided with an air extraction mechanism, a vacuum indication assembly, a first switch and a second switch. For the second switch, a control assembly is provided. The first switch and the second switch control the air extraction mechanism to open or close so as to extract the air in the container thorough. The vacuum indication member is to indicate whether the container is in a vacuum state or not for the user to check air leakage. The control assembly automatically controls connection or disconnection of the second switch, so that the air extraction mechanism is automatically started to extract the air in the container when there is air leakage. In this way, the inside of the container can be kept vacuum all the time, providing fresh-keeping and moisture-proof functions.

### BACKGROUND OF THE INVENTION

1. Field of the Invention

The present invention relates to a container cover, and more particularly to a container cover device which has an automatic vacuum function and is mounted on a container to keep the food and article in the container fresh and to prevent moisture.

2. Description of the Prior Art

A fresh box on the market comprises a container and a simple container cover. The container cover has a seal strip to prevent the external air from entering the container. However, the inside of the container still has a certain air. It is necessary to use an auxiliary extraction apparatus to extract the air in the container. If there is air leakage during preservation, the food won't be kept fresh. This will influence the quality of the food. Sometime, people may eat the bad food to harm health so it is inconvenient for use.

Accordingly, the inventor of the present invention has devoted himself based on his many years of practical experiences to solve these problems.

### SUMMARY OF THE INVENTION

The primary object of the present invention is to provide a container cover device which has an automatic vacuum function to overcome the shortcomings of the prior art.

In order to achieve the aforesaid object, the container cover device of the present invention comprises a container cover used to seal an opening portion of a container. The container cover is provided with an air extraction mechanism used to extract air in the container, a vacuum indication assembly used to indicate whether the air in the container is completely extracted or not, a first switch and a second switch used to control the air extraction mechanism to open or close.

The container cover has a first through hole and a second through hole to communicate with the inside of the container.

The vacuum indication assembly comprises a flexible first rubber pipe, a first spring to extend the first rubber pipe, and an indication knob which is movable by means of the first rubber pipe. The first rubber pipe has a closed end against the indication knob and an open end communicating with the first through hole in a seal way. The first spring is located in the first rubber pipe and held between the first rubber pipe and the container cover. The indication knob is exposed out of the container cover. In a normal pressure state, the first rubber pipe is extended and the indication knob extends out of the container cover. In a vacuum state, the first rubber pipe is retracted and the indication knob is retracted in the container cover.

The second switch and the first switch are connected in series. A control assembly is provided to control connection or disconnection of the second switch. The control assembly comprises a flexible second rubber pipe and a second spring to extend the second rubber pipe. The second rubber pipe has a closed end and an open end. A cap is provided on the closed end of the second rubber pipe. The cap is contact with the second switch. The open end of the second rubber pipe communicates with the second through hole in a seal way. The second spring is located in the second rubber pipe and held between the second rubber pipe and the container cover. The second spring has an elastic force greater than that of the first spring. In a normal pressure state, the second rubber pipe is extended and the second switch is connected. In a vacuum state, the second rubber pipe is retracted and the second switch is disconnected.

The first switch and the second switch are adapted to control the air extraction mechanism to open or close to retract the air in the container thorough. The vacuum indication member is to indicate whether the container is in a vacuum state for the user to check air leakage. The control assembly is to control connection or disconnection of the second switch automatically, so that the air extraction mechanism is automatically started to extract the air in the container when there is air leakage. In this way, the inside of the container can be kept vacuum all the time, providing fresh-keeping and moisture-proof functions. The present invention has a simple configuration and can be used conveniently.

The seal ring on the outer circumferential wall of the container cover cooperates with the pop mechanism to prop the seal ring radially and attach to the inner wall of the container tightly so as to achieve a better seal effect. The operation is very convenient.

The handle is formed with the protruding post. When the handle is turned down, the protruding post presses the first switch so that the first switch is in a connection state. When the handle is turned up, the protruding post will disengage from the first switch so that the first switch is in a disconnection state. This ensures that the user won't forget to open or close the first switch, providing great convenience for the user.

### BRIEF DESCRIPTION OF THE DRAWINGS

FIG. 1 is a perspective view according to a preferred embodiment of the present invention;

FIG. 2 is an exploded view according to the preferred embodiment of the present invention;

FIG. 3 is a partial exploded view according to the preferred embodiment of the present invention;

FIG. 4 is a first sectional view according to the preferred embodiment of the present invention to show that the seal ring is not attached to the inner wall of the container;

FIG. 5 is a sectional view of FIG. 4 to show that the seal ring is to seal the inner wall of the container;

FIG. 6 is a second sectional view according to the preferred embodiment of the present invention to show that the seal ring is not attached to the inner wall of the container;

FIG. 7 is a sectional view of FIG. 6 to show that the seal ring is to seal the inner wall of the container;

FIG. 8 is a third sectional view according to the preferred embodiment of the present invention to show that the seal ring is not attached to the inner wall of the container;

FIG. 9 is a sectional view of FIG. 8 to show that the seal ring is to seal the inner wall of the container;

FIG. 10 is a fourth sectional view according to the preferred embodiment of the present invention to show that the seal ring is not attached to the inner wall of the container; and

FIG. 11 is a sectional view of FIG. 9 to show that the seal ring is to seal the inner wall of the container;

### DETAILED DESCRIPTION OF THE PREFERRED EMBODIMENTS

Embodiments of the present invention will now be described, by way of example only, with reference to the accompanying drawings.

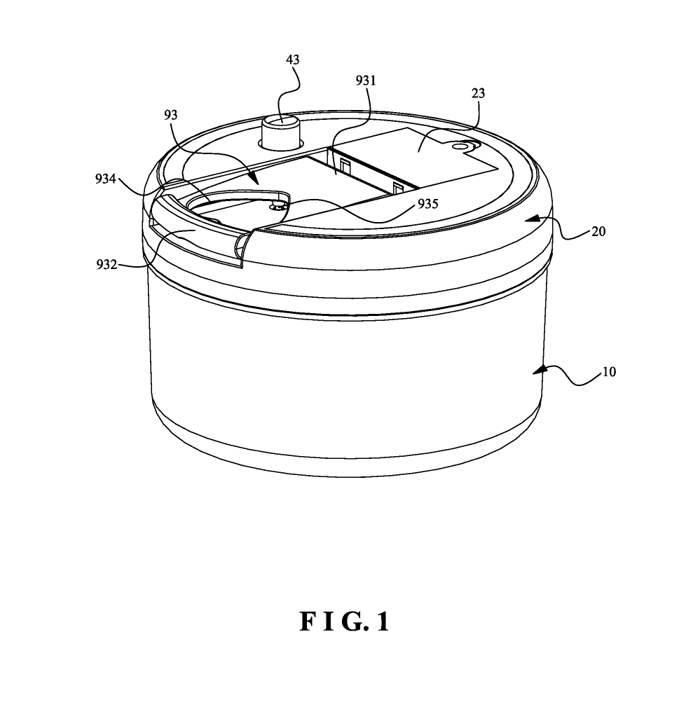

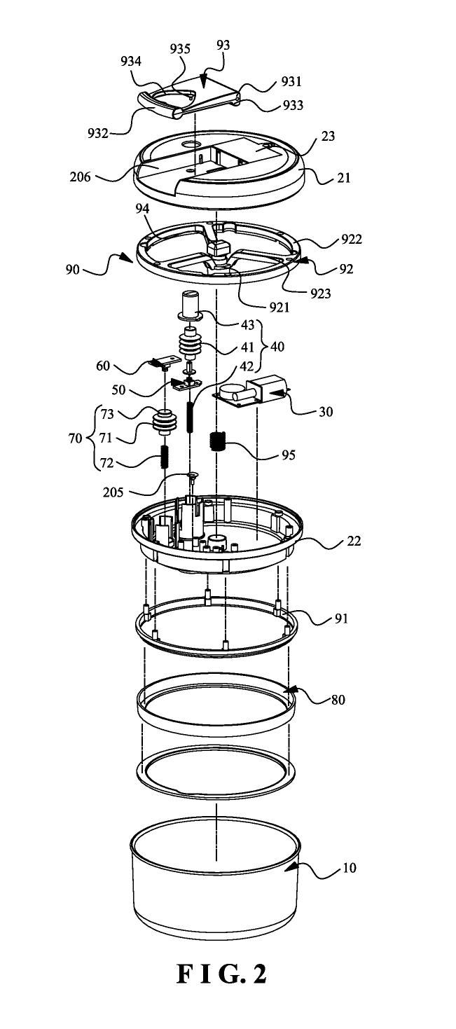

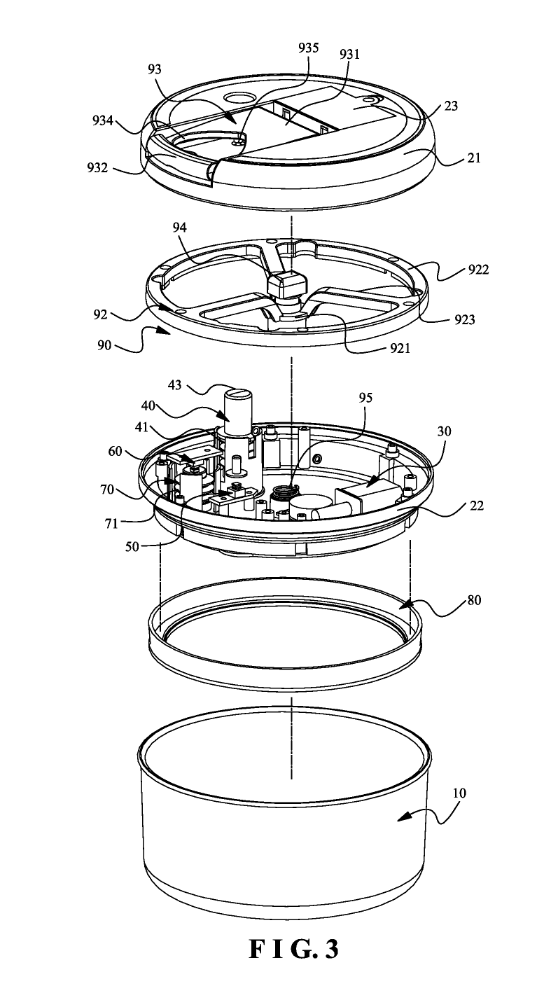

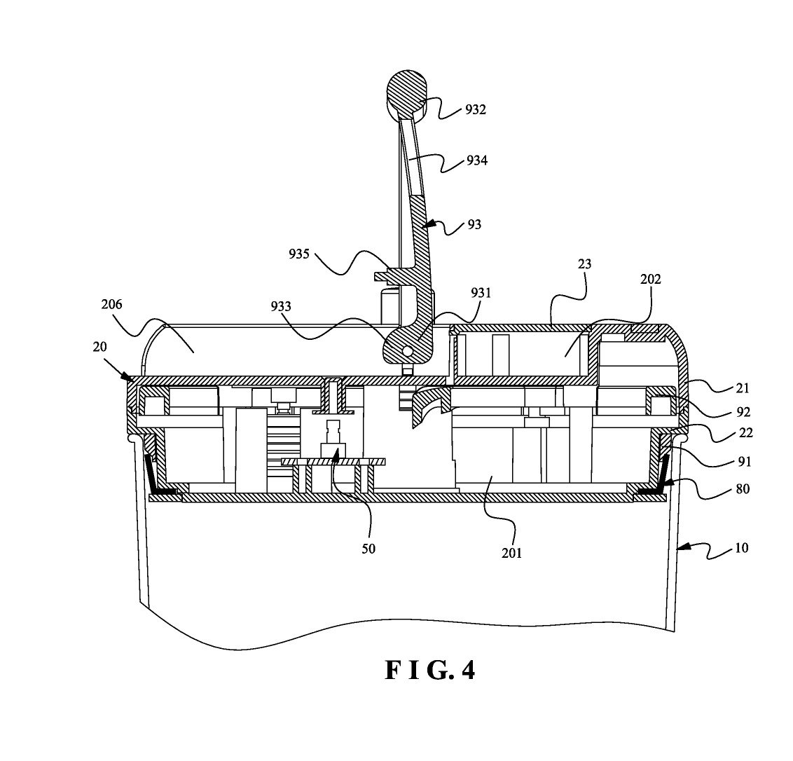

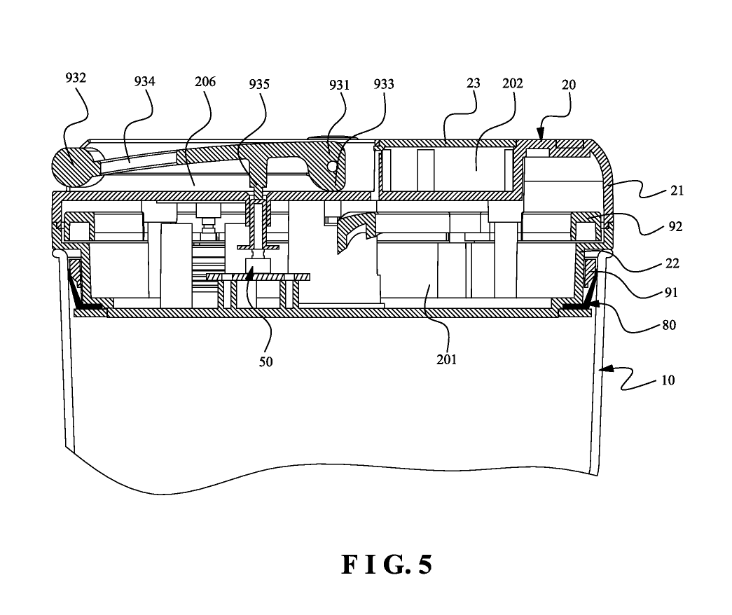

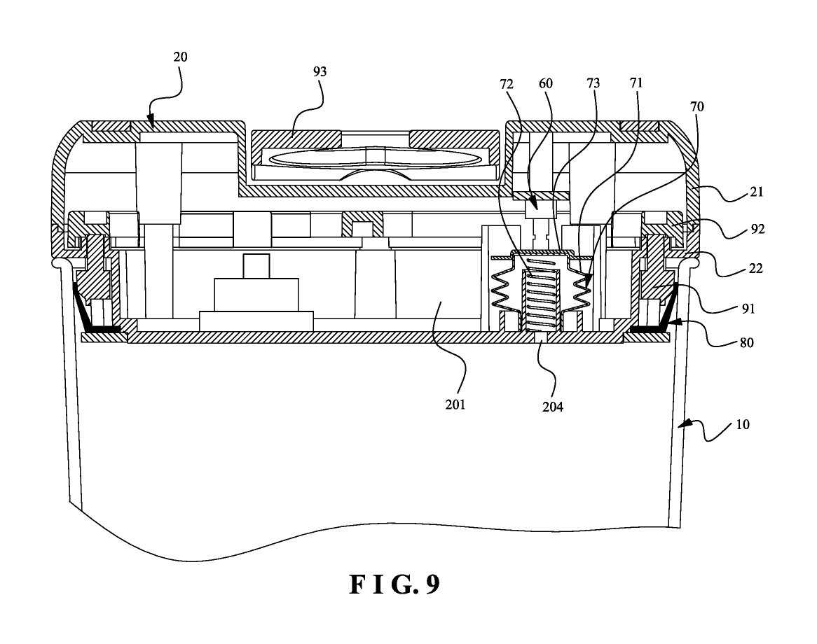

As shown in FIG. 1 to FIG. 11, a preferred embodiment of the present invention comprises a container cover 20 used to seal an opening portion of a container 10. The container cover 20 is provided with an air extraction mechanism 30 used to extract the air in the container 10, a vacuum indication assembly 40 used to indicate whether the air in the container 10 is completely extracted or not, a first switch 50 and a second switch 60 used to control the air extraction mechanism 30 to open or close.

The container 10 can be made of any material, and its opening portion can be in any shape. The container cover 20 corresponds in shape to the opening portion of the container 10. In this embodiment, the container cover 20 has a circular shape, but not limited. The container cover 20 comprises an upper cover 21 and a lower cover 22. The upper cover 21 is located out of the container 10. The lower cover 22 is located in the opening portion of the container 10. The upper cover 21 and the lower cover 22 define a chamber 201 therebetween. All the air extraction mechanism 30, the vacuum indication member 40, the first switch 50 and the second switch 60 are located in the chamber 201. The container cover 20 has an accommodation recess 202 to receive a battery which provides power to the air extraction mechanism 30. The accommodation recess 202 is covered by a lid 23. Besides, the container cover 20 has a first through hole 203, a second through hole 204 and an air nozzle 205 to communicate with the inside of the container 10. The first through hole 203 and second through hole 204 are disposed on the lower cover 22.

The vacuum indication assembly 40 comprises a flexible first rubber pipe 41, a first spring 42 to extend the first rubber pipe 42, and an indication knob 43 which is movable by means of the first rubber pipe 41. The first rubber pipe 41 has a closed end against the indication knob 43 and an open end communicating with the first through hole 203 in a seal way. The first spring 42 is located in the first rubber pipe 41 and held between the first rubber pipe 41 and the container cover 20. The indication knob 43 is exposed out of the container cover 20. In a normal pressure state, the first rubber pipe 41 is extended and the indication knob 43 extends out of the container cover 20 to indicate that there is air in the container 10, not in a vacuum state. In a vacuum state, the first rubber pipe 41 is retracted, the first spring 42 is compressed, and the indication knob 43 is retracted in the container cover 20 to indicate that the container 10 is in a vacuum state.

The second switch 60 and the first switch 50 are connected in series. A control assembly 70 is provided to control connection or disconnection of the second switch 60. The control assembly 70 is located in the chamber 201. The control assembly 70 comprises a flexible second rubber pipe 71, a second spring 72 to extend the second rubber pipe 72. The second rubber pipe 71 has a closed end and an open end. A cap 73 is provided on the closed end of the second rubber pipe 71. The cap 73 is a plastic cap. The cap 73 is contact with the second switch 60. The second switch 60 is located on top of the cap 73. The open end of the second rubber pipe 71 communicates with the second through hole 204 in a seal way. The second spring 72 is located in the second rubber pipe 71 and held between the second rubber pipe 71 and the container cover 20. The elastic force of the second spring 72 is greater than that of the first spring 42. In a normal pressure state, the second rubber pipe 71 is extended and the second switch 60 is connected. In a vacuum state, the second spring 72 is compressed, the second rubber pipe 71 is retracted, and the second switch 60 is disconnected.

The container cover 20 comprises a seal ring 80 on an outer circumferential wall thereof. The seal ring 80 has a cup shape. A prop mechanism 90 is provided on the container cover 20 to prop the seal ring 80 to seal the inner wall of the container 10. In this embodiment, the prop mechanism 90 comprises a slide ring 91, a movable support 92 and a handle 93. The slide ring 91 is located at the inside edge of the seal ring 80. The slide ring 91 is fixedly connected to the movable support 92 and moved along with the movable support 92.

The movable support 92 is located in the container cover 20. The movable support 92 comprises a central portion 921 and an annular portion 922. The annular portion 922 corresponds in shape to the slide ring 91. The slide ring 91 is fixed on the annular portion 922. A plurality of ribs 923 radially extend from the central portion 921. The distal ends of the ribs 923 are connected to and integrally formed with the inner side of the annular portion 922.

The handle 93 is located on the outside of the container cover 20 and brings the movable support 92 to move. The handle 93 has a pivot end 931 and an opposing operation end 932. The pivot end 931 is pivotally connected to the container cover 20. The pivot end 931 is formed with an eccentric block 933 for pushing the movable support 92 downward. The eccentric block 933 pushes the movable support 92 downward through a top block 94 on the movable support 92. A third spring 95 is provided to bias the movable support 92 upward. Both the eccentric block 933 and the top block 94 are located above the center of the movable support 92. The third spring 95 is located under the center of the movable support 92. The operation end 932 is formed with a hole 934 for insertion of the user's finger to control turning of the handle 93. The top of the container cover 20 has a recess 206 to accommodate the handle 93. When the handle 93 is turned down flat, the handle 93 is accommodated in the recess 206.

The handle 93 has a protruding post 935 used to press the first switch 50. When the handle 93 is turned down, the protruding post 935 will press the first switch 50 so that the first switch 50 is connected. When the handle 93 is turned up, the protruding post 935 will disengage from the first switch 50 so that the first switch 50 is disconnected.

The use way of the embodiment is described in detail as follows.

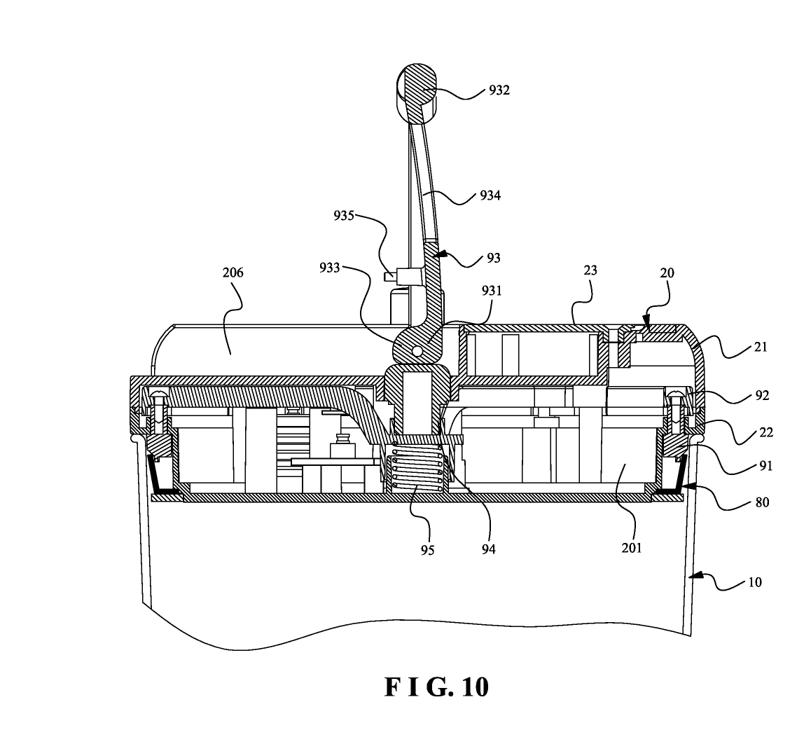

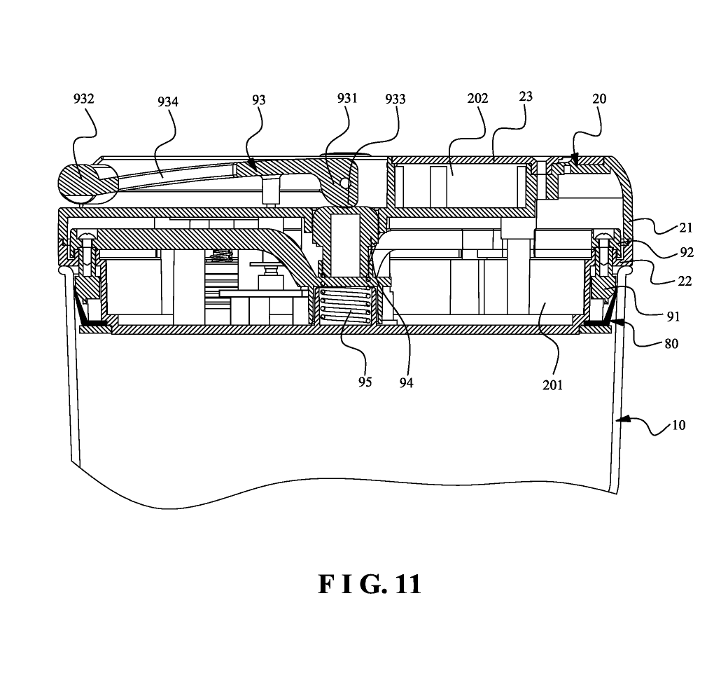

When in use, an article is placed in the container 10 and the lower cover 22 of the container cover 20 sinks in the opening portion of the container 10. After that, the handle 93 is pressed down, as shown in FIG. 10 and FIG. 11. The eccentric block 933 of the handle 93 presses the top block 94 down. The top block 94 presses the movable support 92 down. The movable support 92 compresses the third spring 95. Because the slide ring 91 is fixed to the movable support 92, the slide ring 91 is moved down along with the movable support 92. The inclined surface of the slide ring 91 forces the upper end of the seal ring 80 to prop outward and to attach to the inner wall of the container 10 tightly so as to achieve a seal effect.

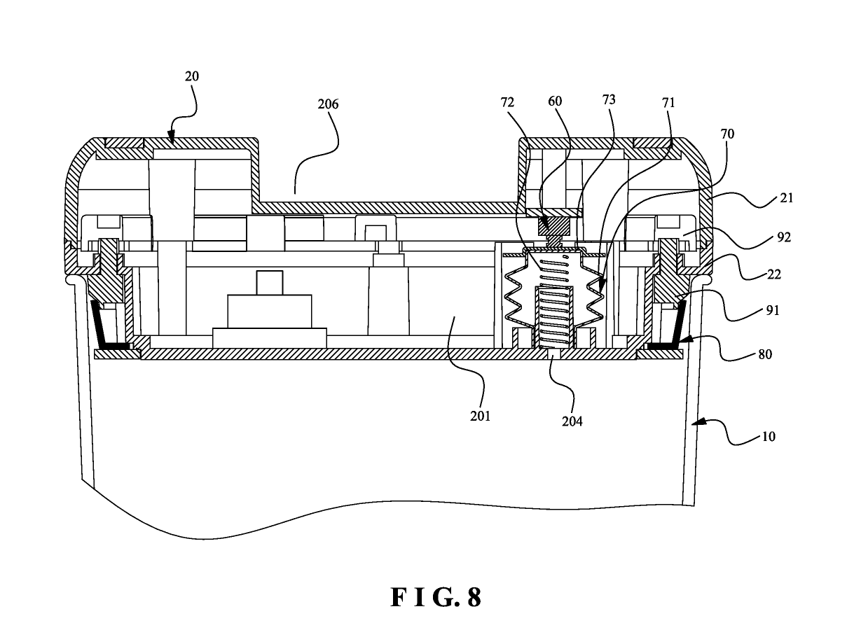

When the handle 93 is pressed down flat, the protruding post 935 of the handle 93 will hold against the first switch 50 to connect with the first switch 50. As shown in FIG. 8, the second rubber pipe 71 communicates with the container 10 through the second hole 204. In this state, the second rubber pipe 71 is extended and its top is against the second switch 60 so the second switch 60 is also in a connection state. The battery supplies power to the pump motor of the air extraction mechanism 30 through the first switch 50 and the second switch 60, and then the pump motor starts to extract the air in the container 10.

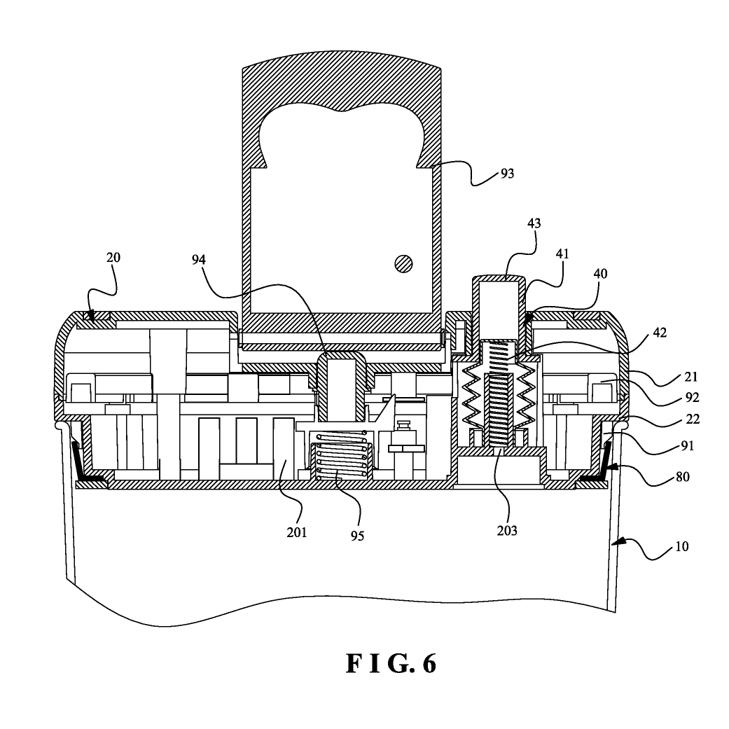

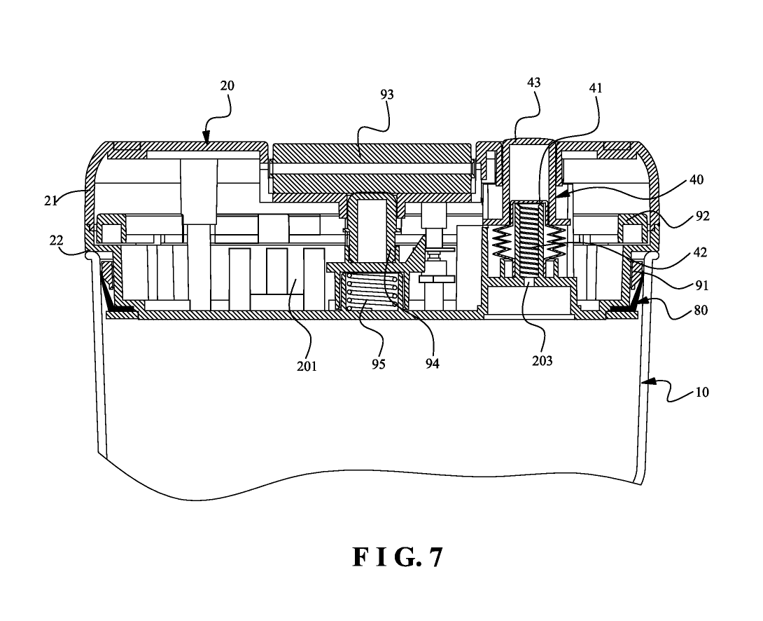

In the meantime, as shown in FIG. 6, the inside of the first rubber pipe 41 also communicates with the container 10. During air extraction, the inside of the container 10 forms negative pressure. As shown in FIG. 7, the first rubber pipe 41 starts to retract and bring the indication knob 43 to move down. Because the elastic force of the second spring 72 is greater than that of the first spring 42, the first spring 42 is also compressed when the first rubber pipe 41 is retracted downward. The second rubber pipe 71 also retracts to compress the second spring 72. The first rubber pipe 41 and the second rubber pipe 42 retract downward asynchronously. The former is slower than the latter. When the container 10 is vacuumed, the first rubber pipe 41 brings the indication knob 43 to a predetermined position and the second rubber pipe 71 also retracts downward. The second switch 60 will be loosened slowly unit disconnection. At this time, the circuit is disconnected and the pump motor of the air extraction mechanism 30 stops running. The inside of the container 10 is in a vacuum state.

After a period of time, there may be air leakage. If air enters the container 10, the degree of vacuum inside the container 10 will be lowered. The first rubber pipe 41 and the second rubber pipe 71 will extend at the same time. When the second rubber pipe 71 extends, its top will press the second switch 60 down. At this time, the second switch 60 is connected and the pump motor of the air extraction mechanism 30 starts to extract the air in the container 10. The degree of vacuum inside the container 10 is enhanced again. The second rubber pipe 71 starts to retract again and its top disengages from the second switch 60, such that the second switch 60 cuts off the circuit. The pump motor of the air extraction mechanism 30 stops running. In this way, the inside of the container 10 can be kept vacuum all the time.

To open the container 10, the handle 93 is pulled upward and the protruding post 935 of the handle 93 disengages from the first switch 50. When the handle 93 is turned 90 degrees, the eccentric block 933 of the pivot end 931 of the handle 93 is displaced, and the top block 94 and the movable support 92 are moved up by the third spring 95, and the slide ring 91 is also moved up. Though the resilience of the seal ring 80, the seal ring 80 retracts inward along the inclined surface of the slide ring 91. Thus, the air enters the container 10 quickly from the inner side edge of the container 10 to balance the inside pressure of the container 10 and the outside pressure. Afterward, the handle 93 is lifted with ease.

It is noted that the first switch 50 can be an independent switch which is manually controlled for connection or disconnection. As to the air inlet portion, the present invention may comprise an independent air inlet button. The present invention is not limited to an independent entire, and its functions can be separated. That is, the vacuum indication assembly 40 and the control assembly 70 are disposed on the top of the container 10. The air inlet portion is also located on the top of the container 10. The air extraction mechanism 30 is disposed at the bottom of the container 10.

First, the feature of the present invention is that the first switch and the second switch control the air extraction mechanism to open or close to retract the air in the container thorough. The vacuum indication member is to indicate whether the container is in a vacuum state for the user to check air leakage. The control assembly is to control connection or disconnection of the second switch automatically, so that the air extraction mechanism is automatically started to extract the air in the container when there is air leakage. In this way, the inside of the container can be kept vacuum all the time, providing fresh-keeping and moisture-proof functions. The present invention has a simple configuration and can be used conveniently. Secondly, the seal ring on the outer circumferential wall of the container cover cooperates with the pop mechanism to prop the seal ring radially and attach to the inner wall of the container tightly so as to achieve a better seal effect. The operation is very convenient. Furthermore, the handle is formed with the protruding post. When the handle is turned down, the protruding post presses the first switch so that the first switch is in a connection state. When the handle is turned up, the protruding post will disengage from the first switch so that the first switch is in a disconnection state. This ensures that the user won't forget to open or close the first switch, providing great convenience for the user.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A container cover device, comprising a container cover used to seal an opening portion of a container, the container cover being provided with an air extraction mechanism used to extract air in the container, a vacuum indication assembly used to indicate whether the air in the container is completely extracted or not, a first switch and a second switch used to control the air extraction mechanism to open or close;
the container cover having a first through hole and a second through hole to communicate with an inside of the container;
the vacuum indication assembly comprising a flexible first rubber pipe, a first spring to extend the first rubber pipe and an indication knob which is movable by means of the first rubber pipe, the first rubber pipe having a closed end against the indication knob and an open end communicating with the first through hole in a seal way, the first spring being located in the first rubber pipe and held between the first rubber pipe and the container cover, the indication knob being exposed out of the container cover, in a normal pressure state, the first rubber pipe being extended and the indication knob extending out of the container cover, in a vacuum state, the first rubber pipe being retracted and the indication knob being retracted in the container cover;
the second switch and the first switch being connected in series, a control assembly being provided to control connection or disconnection of the second switch, the control assembly comprising a flexible second rubber pipe and a second spring to extend the second rubber pipe, the second rubber pipe having a closed end and an open end, a cap being provided on the closed end of the second rubber pipe, the cap being contact with the second switch, the open end of the second rubber pipe communicating with the second through hole in a seal way, the second spring being located in the second rubber pipe and held between the second rubber pipe and the container cover, the second spring having an elastic force greater than that of the first spring, in a normal pressure state, the second rubber pipe being extended and the second switch being connected, in a vacuum state, the second rubber pipe being retracted and the second switch being disconnected.

2. The container cover device as claimed in claim 1, wherein the container cover comprises a seal ring on an outer circumferential wall thereof and a prop mechanism on the container cover for propping the seal ring to seal an inner wall of the container.

3. The container cover device as claimed in claim 2, wherein the prop mechanism comprises a slide ring, a movable support and a handle, the slide ring is located at an inside edge of the seal ring, the slide ring is fixedly connected to the movable support and moved along with the movable support, the movable support is located in the container cover, and the handle is located on an outside of the container cover and brings the movable support to move.

4. The container cover device as claimed in claim 3, wherein the handle has a pivot end and an opposing operation end, the pivot end is pivotally connected to the container cover, the pivot end is formed with an eccentric block for pushing the movable support downward, the eccentric block pushes the movable support downward through a top block on the movable support, a third spring is provided to bias the movable support upward.

5. The container cover device as claimed in claim 4, wherein both the eccentric block and the top block are located above a center of the movable support, and the third spring is located under the center of the movable support.

6. The container cover device as claimed in claim 4, wherein the operation end is formed with a hole for insertion of the user's finger.

7. The container cover device as claimed in claim 4, wherein a top of the container cover has a recess to accommodate the handle, when the handle is turned down flat, the handle is accommodated in the recess.

8. The container cover device as claimed in claim 4, wherein the handle has a protruding post used to press the first switch, when the handle is turned down, the protruding post presses the first switch so that the first switch is connected, when the handle is turned up, the protruding post disengages from the first switch so that the first switch is disconnected.

9. The container cover device as claimed in claim 1, wherein the container cover comprises an upper cover and a lower cover, the upper cover and the lower cover define a chamber therebetween, the air extraction mechanism, the vacuum indication member, the first switch and the second switch are located in the chamber.

10. The container cover device as claimed in claim 1, wherein the container cover has an accommodation recess to receive a battery which provides power to the air extraction mechanism, and the accommodation recess is covered by a lid.
